(19) United States
(12) Patent Application Publication
(10) Pub. No.: US 2010/0306211 A1
(43) Pub. Date: Dec. 2, 2010

(54) METHOD AND APPARATUS FOR AUTOMATIC GEO-LOCATION SEARCH LEARNING

(75) Inventors: Indrajit Chaudhuri, Espoo (FI); Michael Halbherr, Berlin (DE); Axel Schmidt, Berlin (DE); Benjamin Pannier, Berlin (DE); Erik Schmitz, Berlin (DE); Pekka Immonen, Lepsama (FI); Jouko Tenhunen, Helsinki (FI); Acu Baver, Berlin (DE)

Correspondence Address: DITTHAVONG MORI & STEINER, P.C., 918 Prince Street, Alexandria, VA, 22314, US

(73) Assignee: Nokia Corporation, Espoo (FI)

(21) Appl. No.: 12/472,298

(22) Filed: May 26, 2009

(51) Int. Cl. G06F 17/30; G06F 7/08

(52) U.S. Cl. 707/759; 707/769; 707/752; 707/753

(57) ABSTRACT

An approach is provided for automatic geo-location search learning. A geo-location search learning platform receives a query specifying words, and initiates a point-of-interest search on the query, an address search on the query, and a partial search on some of the words. The geo-location search learning platform then combines results of the point-of-interest search, the address search, and the partial search, determines context information for a user; and sorts the combined results based on the context information thereby recommending the researched results to the user in a priority list as sorted.

### BACKGROUND

Wireless (e.g., cellular) service providers and device manufacturers are continually challenged to deliver value and convenience to consumers by, for example, providing compelling network services. One area of interest has been in searching for navigation and geo-locations information of interest when a user is travelling, given the ever growing navigation and geo-location recommendation services and communication means. However, as the use and variety of communication and mobile internet services increase, the user faces the burden of entering sufficient geo-location information associated with each point of interest (POI), such as a hotel, a restaurant, etc.

### SOME EXAMPLE EMBODIMENTS

Therefore, there is a need for a fast and simple approach for handling a geo-location (hereinafter interchangeable with a geo-locatable object) search query and for learning partially and/or fully matched geo-locations base upon the query and context information of the user, such as individual or social-group past usage and behaviors, thereby generating a recommendation list boarder than the user's contemplation and knowledge yet personally relevant.

According to one embodiment, a method comprises receiving a query specifying words. The method also comprises initiating a point-of-interest search on the query, an address search on the query, and a partial search on some of the words. The method further comprises combining results of the point-of-interest search, the address search, and the partial search. The method further comprises determining context information for the user. The method further comprises sorting the combined results based on the context information thereby recommending the researched results to the user in a priority list as sorted.

According to another embodiment, an apparatus comprising at least one processor, and at least one memory including computer program code, the at least one memory and the computer program code configured to, with the at least one processor, cause the apparatus to receive a query specifying words. The apparatus is also caused to initiate a point-of-interest search on the query, an address search on the query, and a partial search on some of the words. The apparatus is further caused to combine results of the point-of-interest search, the address search, and the partial search. The apparatus is further caused to determine context information for the user. The apparatus is further caused to sort the combined results based on the context information thereby recommending the researched results to the user in a priority list as sorted.

According to another embodiment, a computer-readable storage medium carrying one or more sequences of one or more instructions which, when executed by one or more processors, cause an apparatus to receive a query specifying words. The apparatus is also caused to initiate a point-of-interest search on the query, an address search on the query, and a partial search on some of the words. The apparatus is further caused to combine results of the point-of-interest search, the address search, and the partial search. The apparatus is further caused to determine context information for the user. The apparatus is further caused to sort the combined results based on the context information thereby recommending the researched results to the user in a priority list as sorted.

According to yet another embodiment, an apparatus comprises means for receiving a query specifying words. The apparatus also comprises means for initiating a point-of-interest search on the query, an address search on the query, and a partial search on some of the words. The apparatus further comprises means for combining results of the point-of-interest search, the address search, and the partial search. The apparatus further comprises means for determining context information for the user. The apparatus further comprises means for sorting the combined results based on the context information thereby recommending the researched results to the user in a priority list as sorted.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of geo-location search learning, according to one embodiment;

FIG. 2 is a diagram of the components of a geo-location search learning platform according to one embodiment;

FIG. 3 is a flowchart of a process for geo-location search learning, according to one embodiment;

FIG. 4 is flowchart of different searches on a query for fully and partially matched geo-locations, according to one embodiment;

FIG. 5 is a flowchart of partial searching processes, according to one embodiment;

FIG. 6A-6B are flowcharts for each of the partial searching processes in FIG. 5, and FIG. 6C illustrates how subqueries are generated from a query, in accordance certain embodiments;

FIG. 7A-7C are flowcharts of a process for combining search results, according to one embodiment;

FIG. 8 is a diagram of hardware that can be used to implement an embodiment of the invention;

FIG. 9 is a diagram of a chip set that can be used to implement an embodiment of the invention; and

FIG. 10 is a diagram of a mobile station (e.g., handset) that can be used to implement an embodiment of the invention.

### DESCRIPTION OF PREFERRED EMBODIMENT

A method and apparatus for geo-location search learning are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term a “social group” refers to two or more humans that interact with one another, accept expectations and obligations as members of the group, and share a common group identity. By this definition, society can be viewed as a large group, though most social groups are considerably smaller. A social group exhibits some degree of social cohesion and is more than a simple collection or aggregate of individuals, such as shared interests, values, ethnic or social background, kinship ties, social interaction, etc. Types of social groups include: social network groups and sub-groups, peer groups, cliques, clubs, households, communities, franchises, teams, etc.

Although various embodiments are described with respect to a geo-location search learning platform residing on mobile user equipment, it is contemplated that the approach described herein may reside in a server of a service provider.

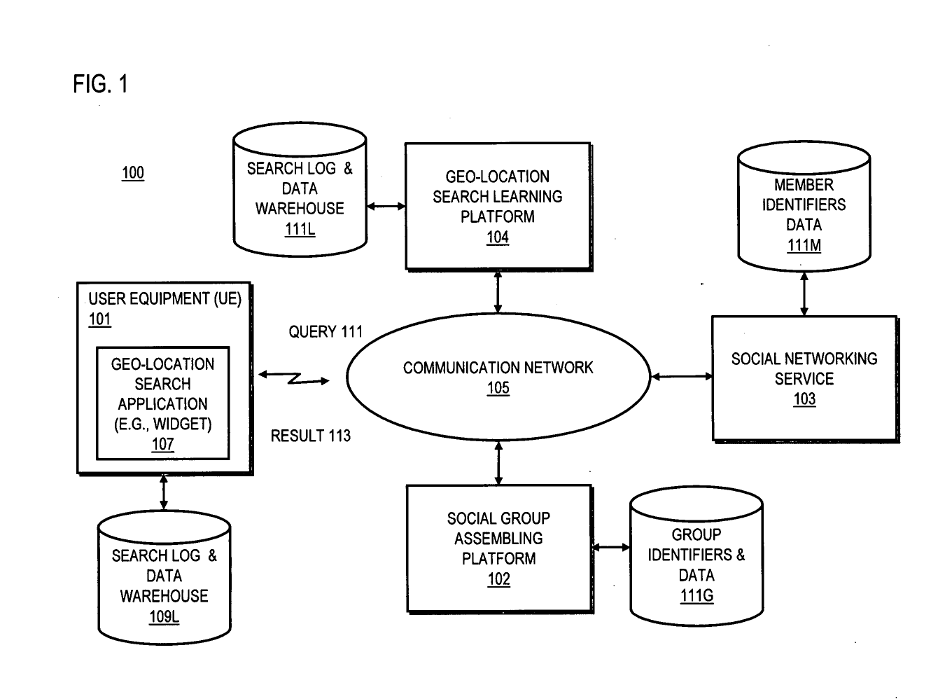

FIG. 1 is a diagram of a system capable of geo-location search learning, according to one embodiment. As shown in FIG. 1, system 100 comprises a user equipment (UE) 101 having connectivity to a social group assembling platform 102, a social networking service 103, and a geo-location search learning platform 104 via a communication network 105. The social group assembling platform 102, the social networking service 103, and the geo-location search learning platform 104 can be implemented via shared or partially shared hardware equipment or different hardware equipments. The UE 101 sends a search query 111 to the geo-location search learning platform 104, and then receives search results 113 therefrom. In certain embodiments, the query 111 can be specified by the user; alternatively, a robot or sensor in the UE 101 can generate the query. It is noted that manufacturers of navigation devices, mobile internet devices, or any terminal device providing capability to find geo-positions are continually challenged to deliver value and convenience to consumers by, for example, performing a location oriented search for any geo-positionable item such as an address or a point of interest or any other related geo-coded media. The system 100, in certain embodiments, supports searching for location oriented data and content in a context sensitive manner whereas the users' context information is defined from both user equipment and a server working in conjunction therewith.

To find “known” or “unknown” places globally or nearby or already known place, users of different terminal interfaces, such as a web browser within a personal computer or an application on a mobile terminal, typically enter a query in a search box to find the place the users are interested in. This comprises, for example, entering at least a keyword or a phrase partially or fully in certain cases, or a keyword or phrase which the user is not exactly sure.

Sometimes the query is too broadly defined for a lookup all over the area, or sometimes it is too narrowly defined within the nearby area where the user's position as identified by a map cursor on a mapping application or by a Global Positioning System (GPS) device or a Cell-ID based positioning devices. Although there are existing digital maps for modern GPS and mobile devices that include a basic selection of point of interest (POI) for a map area, the searches are typically based upon the exactly matched POI or address entered into a search box, i.e., adopting the narrowest interpretation of the query, to retrieve a relevant map, rather than interpreting/translating a query in a flexible and intelligent manner.

For example, a conventional searching approach narrows a query, such as “luxury hotel Berlin Germany” into “luxury hotels in Berlin.” It is challenging for the users to find and explore an area with limited knowledge what they could be looking for (such as luxury hotels in Germany) and what they may be interested in (such as luxury Germany hotels). As another example, a searching approach narrows a query of “concert hall Berlin Germany” into “concert halls in Berlin,” without ever considering “concert halls in Germany,” “concerts in Berlin,” etc. In such situations, the users need a flexible, intelligent yet fast searching approach to obtain a plurality of broader searches, and then reduce and sort the search results in conjunction with the users' context information, such as individual or social-group past usage and behaviors. To address this problem, the system 100 of FIG. 1 introduces the capability of geo-location search learning via the platform 104, which is accessible over the communication network 105.

By way of example, the communication network 105 of the system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), the Internet, or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, mobile ad-hoc network (MANET), and the like.

The UE 101 is any type of mobile terminal, fixed terminal, or portable terminal including a mobile handset, station, unit, device, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.). In certain embodiments, the UE 101 has connectivity to a search log and data warehouse 109L. The search log and data warehouse 109L may include data stored in, for instance, any number of fields, including, for example, name of a search, search result, address, landmark, point of interest and other related information fields. Moreover, the data may be associated with the UE 101 itself or with one or more social groups the user belongs to.

By way of example, the UE 101, the social group assembling platform 102, the social networking service 103, and the geo-location search learning platform 104 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

The social group assembling platform 102 may be implemented via computers using existing social network analysis software tools to identify, represent, analyze, visualize, or simulate nodes (e.g. agents, organizations, or knowledge) and edges (relationships) from various types of input data (relational and non-relational), including mathematical models of social networks. These tools allow researchers to investigate representations of networks of different size—from small (e.g. families, project teams) to very large (e.g. the Internet, disease transmission) and to generate group identifiers and data 111G. The various tools, such as C-Finder®, Idiro Customer Intelligence®, iPoint®, deploy complicated mathematical and statistical routines that have to be implemented via high-computing power processors and take a long time to complete the computation. The system 100 uses algorithms to generate user groups or social groups based on contextual and statistical history and to map the user to a certain group without identifying the user.

The social networking service 103 can be provided by social network websites such as MySpace®, Facebook®, etc., or via a personal information management web service (e.g., Ovi®), etc. Typically, each service or application manages its respective set of contacts/members identifiers and data 111M independently.

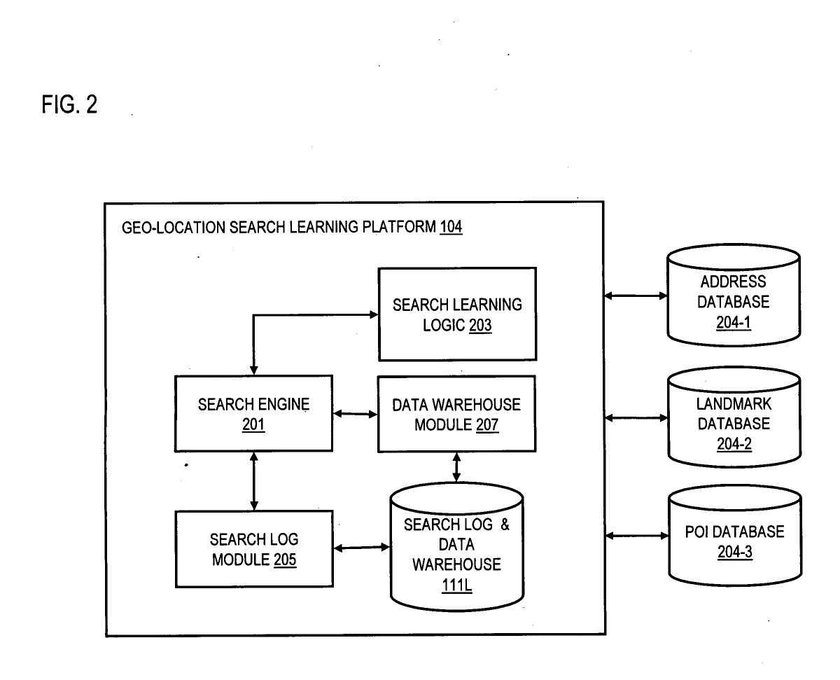

FIG. 2 is a diagram of the components of the geo-location search learning platform 104 according to one embodiment. By way of example, the geo-location search learning platform includes one or more components for providing geo-location search learning. It is contemplated that the functions of these components may be combined in one or more components or performed by other components of equivalent functionality. In this embodiment, the geo-location search learning platform 104 includes at least a search engine 201, a search learning logic 203 which contains at least one algorithm for performing different kinds of geo-location searches, a search log module 205 for logging search queries and subqueries, a data warehouse module 207 for warehousing search results, and a search log and data warehouse 111L. The geo-location search learning platform 104 conducts different kinds of geo-location searches against at least an address database 204-1, a landmark database 204-2, and a POI database 204-3.

Alternatively, the functions of the geo-location search learning platform 104 can be implemented via a geo-location search application (e.g., widget) 107 in the user equipment 101 according to another embodiment. Widgets are light-weight applications, and provide a convenient means for presenting information and accessing services. It is contemplated that the functions of these components may be combined in one or more components or performed by other components of equivalent functionality. In this embodiment, the geo-location search application 107 includes an off-line search engine, a search learning logic which contains at least one algorithm for performing the different kinds of geo-location searches, a search log module for logging search queries and subqueries, a data warehouse module for warehousing search results, and a search log and data warehouse 109L. To avoid data transmission costs as well as save time and battery, the off-line search engine can conduct searches data cached or stored in the search log and data warehouse 109L, without requesting data from any servers or external platforms, such as the social group assembling platform 102, the social networking service 103, and the geo-location search learning platform 104. Usually, if the user equipment is online, search queries are made to online search server backends, and once the device is off-line, searches are made to off-line indexes locally.

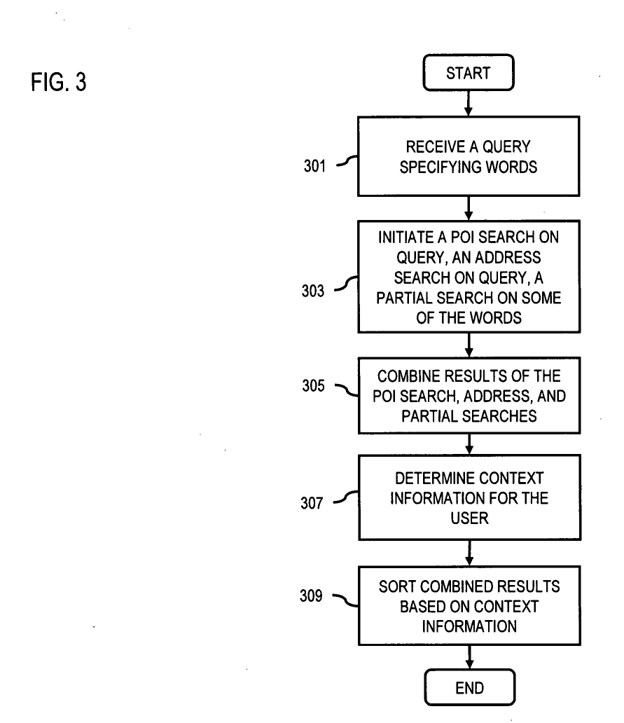

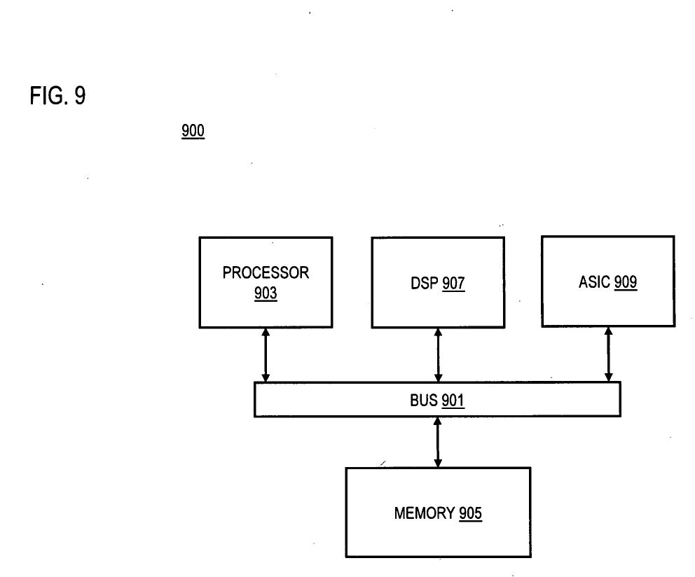

FIG. 3 is a flowchart of a process 300 for geo-location search learning, according to one embodiment. In this embodiment, the geo-location search learning platform 104 performs the process 300 and is implemented in, for instance, a chip set including a processor and a memory as shown FIG. 9. In step 301, the geo-location search learning platform 104 receives a query specifying words, such as “hotel Berlin Germany.” As mentioned a user can manually input the query, according to one embodiment; in the alternative, the query can be automatically generated on behalf of the user using for instance, a robot or other equivalent mechanism. As the user enters the words, the geo-location search learning platform 104 initiates a point-of-interest search on the whole query, an address search on the whole query, and a partial search on some or multiple combinations of the words in the query, such as “hotel Berlin” (Step 303). It is contemplated that the geo-location search learning platform 104 may wait for the user to enter all words in a query, or expends the searches on the fly as the user is entering words. The geo-location search learning platform 104 then combines results of the point-of-interest search, the address search, and the partial search (Step 305). The geo-location search learning platform 104 then determines context information for the user (Step 307) prior to a Step 309. In the Step 309, the geo-location search learning platform 104 sorts the combined results based on the context information thereby recommending the researched results to the user in a priority list as sorted.

The context information contains, in one embodiment, personalized relevancy that is determined by considering the user's and likeminded users' habits and preferences. When sorting searched geo-locations that are outside of the user's typical situations, the geo-location search learning platform 104 sorts the search results based upon the context information, such as (1) where people of the same social group are going in this area, (2) where people of the same social group are in this area now, and (3) where people of the same social group typically visit in this area at the given time or combinations of at least two of (1)-(3).

According to one embodiment, the geo-location search learning platform 104 uses a user's context information based on the user's profile, date, time of day, terminal used, current location, the user's profile based on a server side analytic system which identifies the user as belonging to a social group based on the user's past behavior and usage of the terminal, so as to sort geo-location search results which suit the user's particular context at the time point of performing the search.

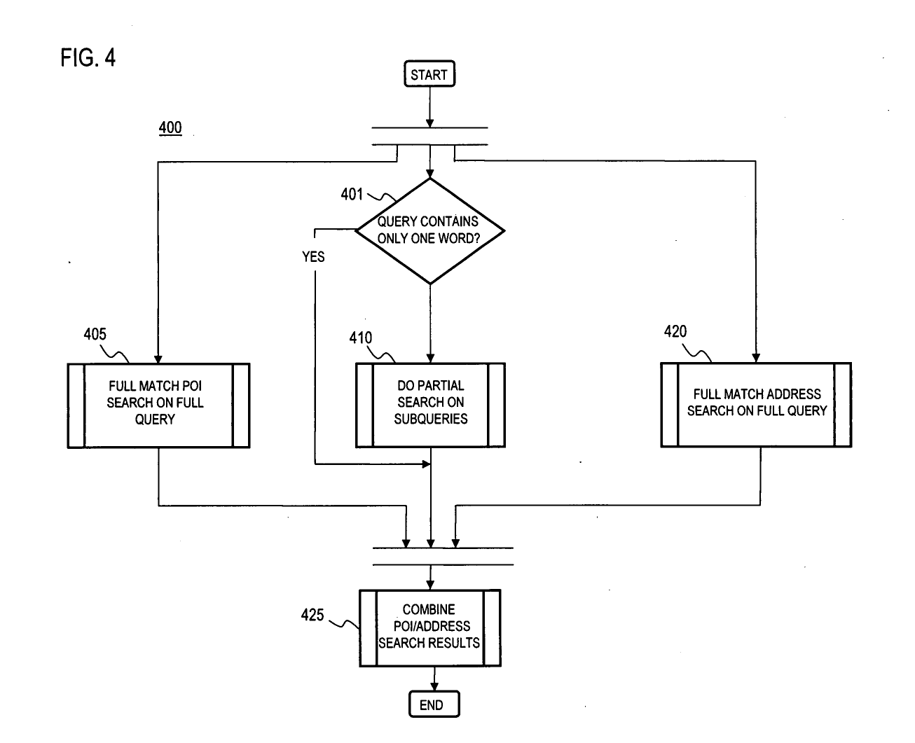

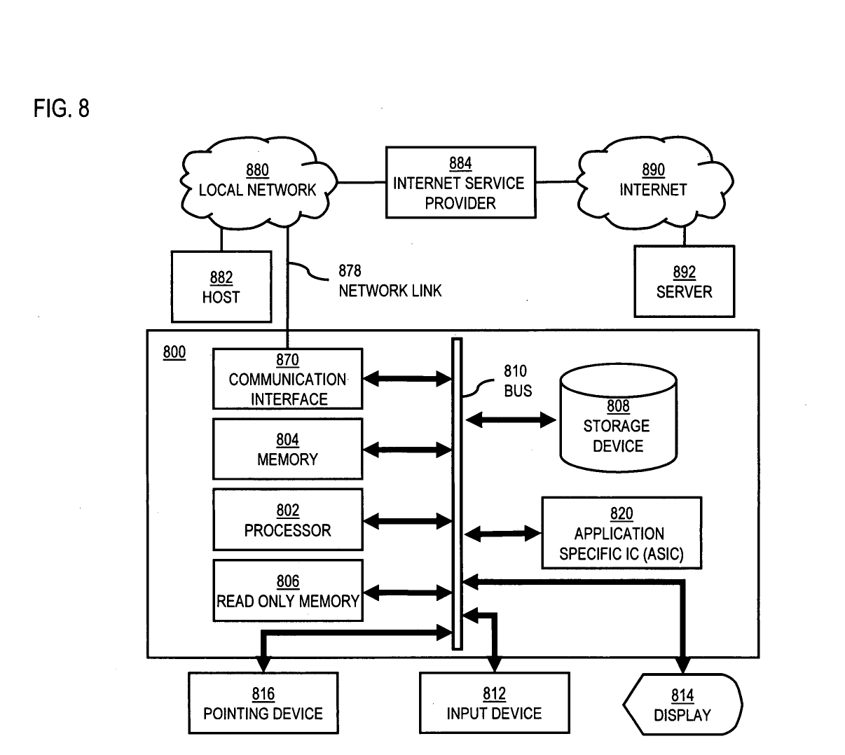

FIGS. 4-6 are flowcharts of processes for fully and partially matched geo-locations according to one embodiment. In this embodiment, the geo-location search learning platform 104 performs the process 400 implemented in by a chip set. For instance, the chip set including a processor and a memory as shown FIG. 8.

According to one embodiment, the geo-location search learning platform 104 conducts a combination of several internal search categories in parallel, such as an Address Search, a Landmark Search, and a POI search. The Address Search is designed to identify an address based upon a given search query and data of locally or system-wide stored street names. The address search can results in more than one address which contains therein at least one word in the search query. For example, a search query of “New York Nokia Street” might come back with a city “New York, US”, a city “York, UK,” a street “York, New Street, UK”, and a street “Nokia Street, Vammala, Finland”. The Landmark Search is designed to identify landmarks such as important and famous buildings, lakes, mountains, etc. This search operates similarly to the Address Search, while the data of the landmarks is stored in a different database from the address database.

In case of off-line search, the address database and the landmark database may be made only partially available. For example, by pre-embedding indexes for global countries, global cities, and/or a country-specific streets (which covers only streets in one country due to typically large sizes of street indexes and limited memory available in a user terminal). Optionally, the device may either automatically or by prompting the user to initiate download of an additional index for example another country-specific street index, when the user roaming in a foreign country. Alternatively, complementary index may be downloaded during an online session without explicit user prompts, together with some other relevant data such as maps data. Once the complementary index is downloaded to the device, it may be deleted after use or stored for future use.

In one embodiment, the POI Search operates technically different from the other two searches. It has to include all words in the search query, i.e., not to ignore any word in the search query like the other two searches. For example, when the search query is “Hotel Fancy,” the POI search cannot find anything, even when there are POIs which names including “Hotel” or “Fancy”. In another embodiment, the system 100 allows partial POI searches. It is contemplated that the different searches can be designated to be conducted “globally” or “nearby.”

FIG. 4 is a flowchart of a process for finding an address, a POI or a landmark based upon a search query entered into a single search box and an algorithm to process at least one of the search categories or to mix search results from some of the search categories. For examples, the geo-location search learning platform 104 receives a search query of “Paris Hilton” to find all Hilton Hotels in Paris, a search query of “Brandenburg gate Coffee” to find the next coffee shops closest to the Brandenburg Gate in Berlin.

The geo-location search learning platform 104 generates the search results and displays the search results on a screen while the user is typing in the query in a search box in a user interface. Such a user interface for providing search results to different users using different kinds of terminal devices ranges from a desktop pc to a mobile terminal device.

In step 401 of FIG. 4, the geo-location search learning platform 104 receives a search query from a user. This query may be initiated by entering the displayed query, while the platform 104 automatically searches geo-locations as the query being entered. As the user enters the search query, the geo-location search learning platform 104 automatically search the whole query against the address database 204-1 and the POI database 204-3 while searches a part of the query against the address database 204-1 in parallel (steps 405, 410 and 415). Optionally, the searches are predictive so that the user only needs to specify the start of a term which needs to be found. For example, when typing “brand g,” the system 100 will find “Brandenburg gate”.

In step 405, the geo-location search learning platform 104 searches in the POI database 204-3 for fully matched terms and display the terms accordingly. In step 420, the geo-location search learning platform 104 searches in the address database 204-1 for fully matched terms and display the terms accordingly. Prior to executing step 410, the geo-location search learning platform 104 determines whether the query contains only one word (Step 401). If the query contains only one word, the geo-location search learning platform 104 skips the step 410 of partial search on subqueries (details shown in FIG. 4B). If the query contains two or more words, the geo-location search learning platform 104 proceeds to the Step 410 of partial search on subqueries. The geo-location search learning platform 104 then combines results of the parallel searches (Step 425). In another embodiment, the address database 204-1 is replaced with the landmark database 204-2.

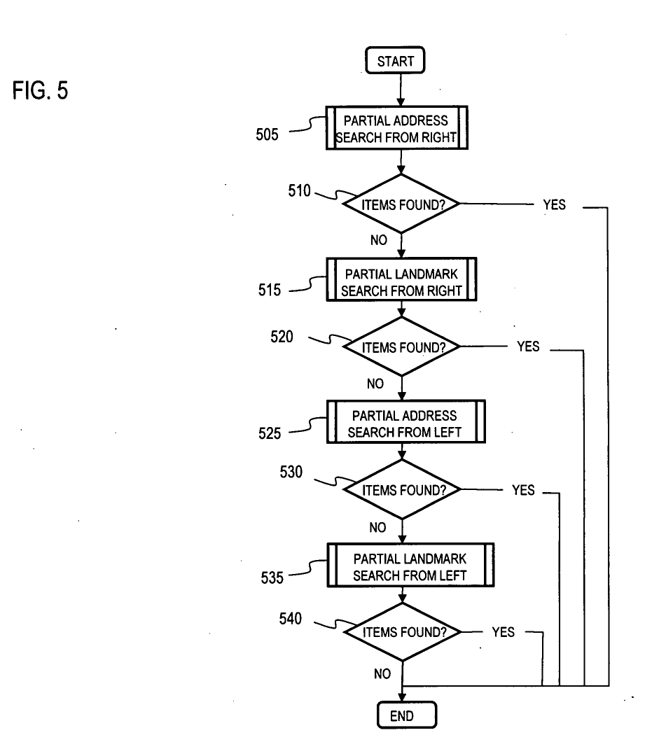

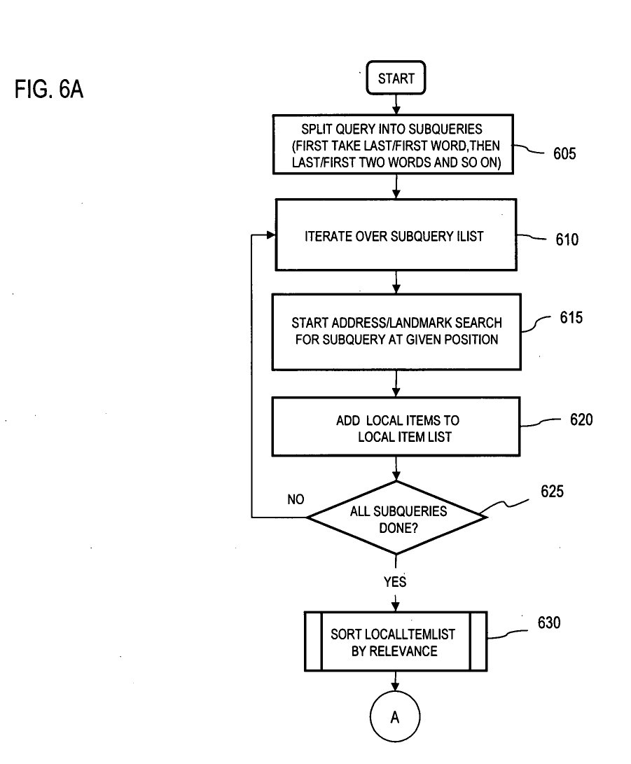

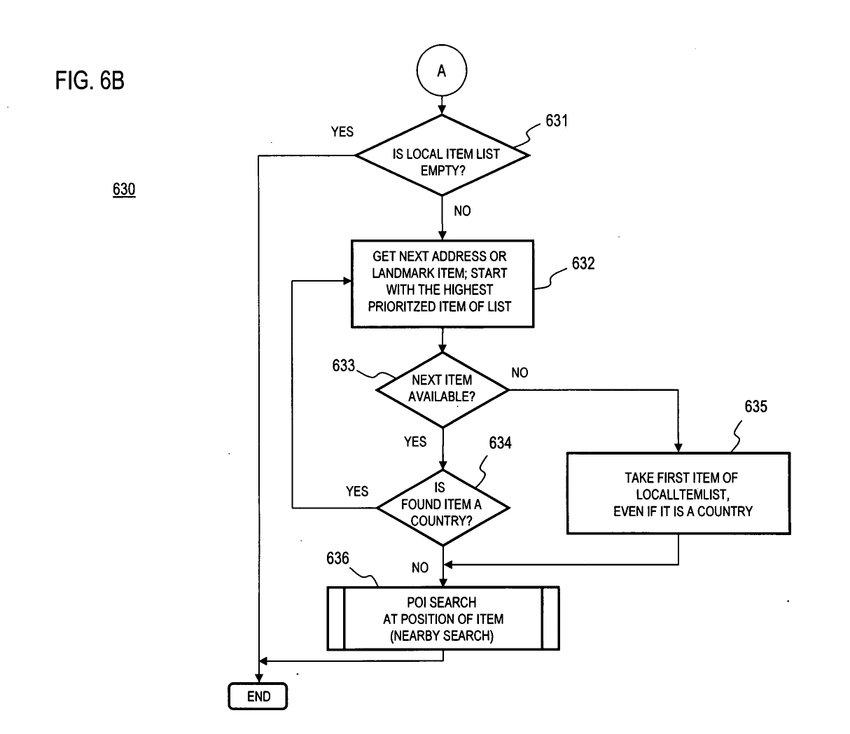

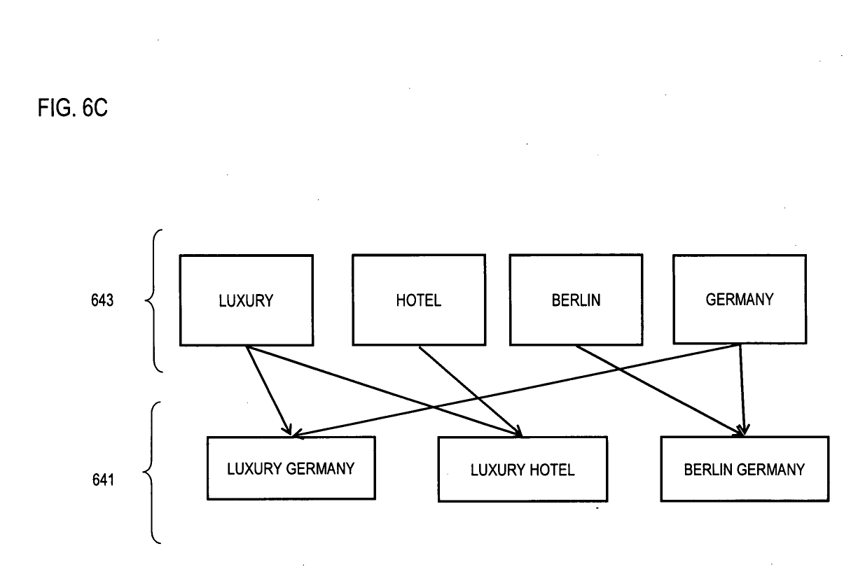

In FIG. 5, the geo-location search learning platform 104 conducts a first partial Address Search based upon a first word/phrase in the query from the right following the flowchart depicted in FIG. 6A (Step 505). If any phrase containing the first right word/phrase is found in the address database (Step 510), the geo-location search learning platform 104 compiles the words/phrases into the search result and ends the partial search on subqueries. If no word/phrase containing the first right word/phrase is found in the address database, the geo-location search learning platform 104 conducts a first partial Landmark Search based upon the first right word/phrase in the query following the same flowchart depicted in FIG. 6A (Step 515). If any word/phrase containing the first right word/phrase is found in the landmark database (Step 520), the geo-location search learning platform 104 compiles the words/phrases into the search results and ends the partial search on subqueries. If no word/phrase containing the first right word/phrase is found in the landmark database, the geo-location search learning platform 104 conducts a second partial Address Search based upon a second word/phrase in the query from the left following the same flowchart depicted in FIG. 6A (Step 525). The geo-location search learning platform 104 then conducts steps 530, 535 and 540 similarly as the steps 510, 515 and 520 for the left word/phrase in the query. By analogy, the geo-location search learning platform 104 then conducts similar steps for the left word/phrase in the query, etc., until finishing partial searches for all words in the query. In one embodiment, the partial searches can be initiated from the left word/phrase rather than the right word/phrase in the query, or even from an intermediate word/phrase in the query (e.g., a middle word/phrase). Alternatively, the partial searches can be initiated from any word/phrase at a given position in the query, and then alternates between the words/phrases on the right and the left sides of the word/phrase at the given position.

As shown in FIG. 6A, the geo-location search learning platform 104 conducts the partial Address/Landmark Search based upon the words in the query. In step 605, the geo-location search learning platform 104 splits the query into subqueries that are groups of one word, two words, three words, etc. For example, the geo-location search learning platform 104 first takes the first word and the last word in the query as a subquery, and then takes first two words as a subquery and the last two word as a subquery, and so on. FIG. 6C illustrates how subqueries 641 are generated from a query 643 “luxury hotel Berlin Germany”. The geo-location search learning platform 104 first takes the first word “luxury” and the last word “Germany” into a Sub-Query 1 “luxury Germany.” The geo-location search learning platform 104 then takes the first two words into a Sub-Query 2 “luxury hotel” and the last two words into a Sub-Query 3 “Berlin Germany.” Thereafter, the geo-location search learning platform 104 assembles the subqueries into a subquery list (Step 610), conducts a search against the address/landmark database for each subquery in the subquery list (Step 615), and adds matched terms into a local item list (Step 620). The subquery process 415 continues until the geo-location search learning platform 104 completes searches for all subqueries in the subquery list (Step 625), and then proceeds to sort all of the matched terms in the local item list by relevance to the user's context information (Step 630).

FIG. 6B contains the detailed steps by the geo-location search learning platform 104 when sorting all of the matched terms in the local item list by relevance to the user's context information until the completing all matched item in the local item list, and ends the partial search process (Step 631). The geo-location search learning platform 104 sorts the matched items by inserting a next matched item (either an address or a landmark) under process into a sequence of already sorted matched items based upon a predetermined priority (Step 632). If the geo-location search learning platform 104 determines the address or landmark as a country (Step 634), the search engine skips inserting the country item, and proceeds to the next item (Steps 633-634). However, if there is no next item available, the geo-location search learning platform 104 inserts the county item into the sequence (Step 635). The geo-location search learning platform 104 combines the full and partial address/landmark search results with the full and partial POI search results in a Step 636 (also see Step 420 in FIG. 4).

According to one embodiment, the system 100 considers both a primary midpoint (i.e., a current GPS position) and a secondary search midpoint (e.g., a found address) by searching a near-by POI with respect to the current (GPS) location and a near-by POI with respect to the most relevant secondary search midpoint. For example, the query of “pizza Rome will get a local “Pizzeria Rome” behind the corner as a POI, as well as certain pizzeria in Rome Italy as POIs, since the secondary search midpoint is Rome.

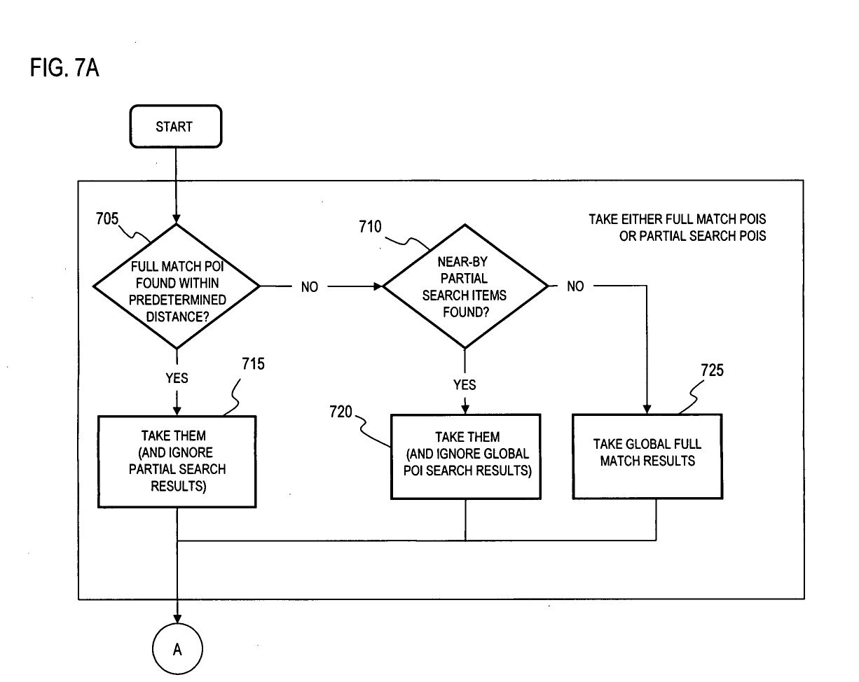

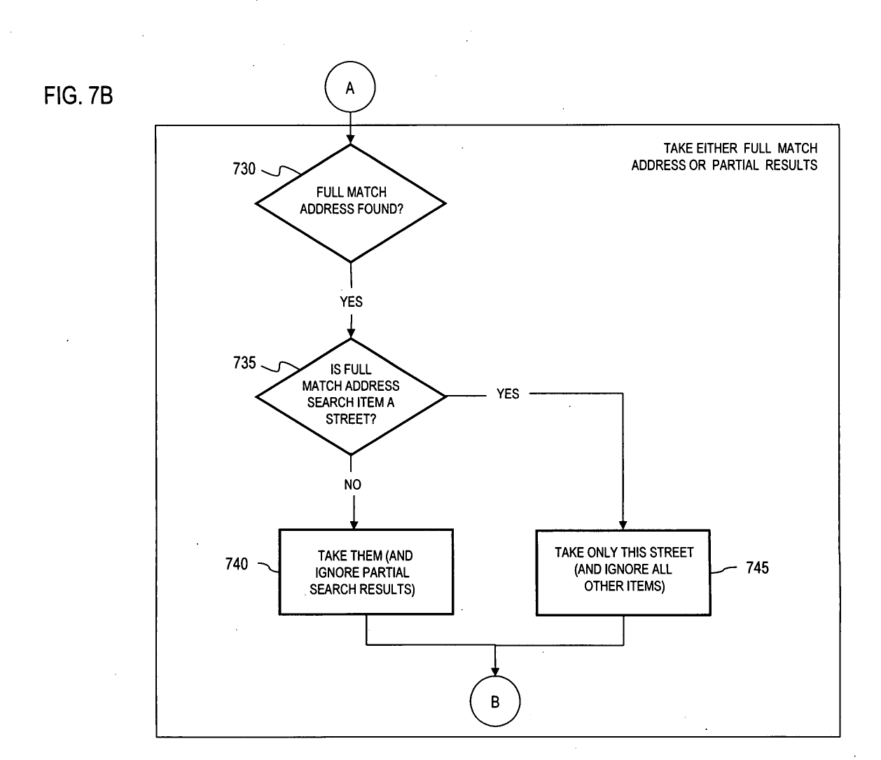

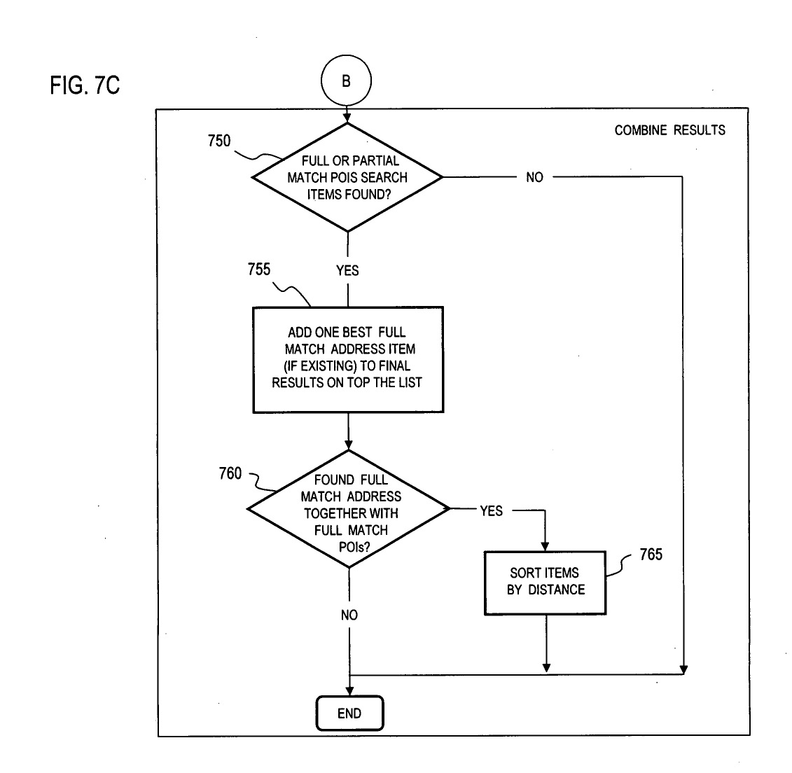

FIGS. 7A-7C are flowcharts of combining search results, according to one embodiment. FIG. 7A depicts one example of how the address/landmark search results are combined with the POI search results. If the geo-location search learning platform 104 finds a fully matched POI item, such as “Chinese vegetarian restaurant”, within a predetermined distance, e.g., 100 km, of a current location (Step 705), platform 104 processes with the fully matched POI item (Step 710) and ignores partial matched POI items (or simply skips any partial POI searches). If the geo-location search learning platform 104 does not find any fully matched POI item within the predetermined distance, the geo-location search learning platform 104 conducts partial near-by POI searches (Step 715), and processes with partially matched near-by POI items, such as “Chinese restaurant” or “vegetarian restaurant” (Step 720) and ignores fully matched global POI items (or simply skips any fully matched global POI searches). If the geo-location search learning platform 104 does not find any partially matched near-by POI items, the geo-location search learning platform 104 processes with fully matched global POI item (Step 725).

In parallel with or in series to the steps 705-725 in FIG. 7A, the geo-location search learning platform 104 conducts steps 730-745 in FIG. 7B as follows. The geo-location search learning platform 104 searches for a fully matched address item (Step 730), determines if the fully matched address item is a street (Step 735). If the fully matched address item is not a street, the search engine processes with the fully matched address item (Step 740), and ignores partial matched address search results. If the fully matched address item is a street, the search engine processes with only the street (Step 745), and ignores all other matched address search results. In another embodiment, the address searches are replaced by landmark searches.

In order to combine POI search results with the address/landmark search results, the geo-location search learning platform 104 conducts steps 750-765 in FIG. 7C as follows. The geo-location search learning platform 104 determines whether there are fully or partially matched POI search results (Step 750). If no, the search engine ends the processing. If yes, the geo-location search learning platform 104 adds the best fully matched address item on the top of the final list (Step 755). The geo-location search learning platform 104 then determines whether a fully matched POI item matches with a fully matched address item (Step 760). If not, the geo-location search learning platform 104 ends the processing. If yes, the geo-location search learning platform 104 sorts the final list by distance (Step 765).

In the first embodiment, the geo-location search learning platform 104 conducts a near-by POI search with the given search query while it conducts an address/landmark search. Thus, even when an address/landmark is identified as a location, the geo-location search learning platform 104 also find near-by POIs by the given search query. For example, a search query of “pizza new york” will find all pizza places in New York as well as all pizza places close to the user's current location which have the term “New York” in their names.

In another embodiment, the geo-location search learning platform 104 attempts to identify an Address via the Address Search with a given search query. If one address could be identified, a near-by POI search will be started with the identified address and all the remaining words in the given search query which are not included in the identified Address. If no address was identified with the given search query, the geo-location search learning platform 104 tries to identify a Landmark via the Landmark Search. If a Landmark is identified, the geo-location search learning platform 104 use the identified landmark as in the query to conduct a near-by POI search. If neither an address nor a landmark was identified, the Geo-location search learning platform 104 conducts a global POI search for the given search query.

It is contemplated that the application user interface, which utilizes geo-location search learning platform 104 may use any means to highlight the matched terms (e.g., highlight matched terms in a different color or type face, mark matched entries with an icon, marked matched entries with a text label, group matched entries together, audible alert when the matched entry is selected, etc).

The search categories are different from another perspective. The addresses change frequently, while the landmarks are stabile and rarely change (such as famous buildings etc). In case of the Landmark Search, it may be conducted reliably based upon the off-line index as cached or stored even if the user terminal is online.

The processes described herein for providing geo-location search learning may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 8 illustrates a computer system 800 upon which an embodiment of the invention may be implemented. Computer system 800 is programmed to support geo-location search learning as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 810 includes one or more parallel conductors of information so that information is transferred quickly among devices coupled to the bus 810. One or more processors 802 for processing information are coupled with the bus 810.

A processor 802 performs a set of operations on information related to geo-location search learning. The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions for geo-location search learning. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for geo-location search learning, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for geo-location search learning to the UE 101.

The term computer-readable medium is used herein to refer to any medium that participates in providing information to processor 802, including instructions for execution. Such a medium may take many forms, including, but not limited to, non-volatile media, volatile media and transmission media. Non-volatile media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

FIG. 9 illustrates a chip set 900 upon which an embodiment of the invention may be implemented. Chip set 900 is programmed to perform geo-location search learning as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to perform geo-location search learning. The memory 905 also stores the data associated with or generated by the execution of the inventive steps.

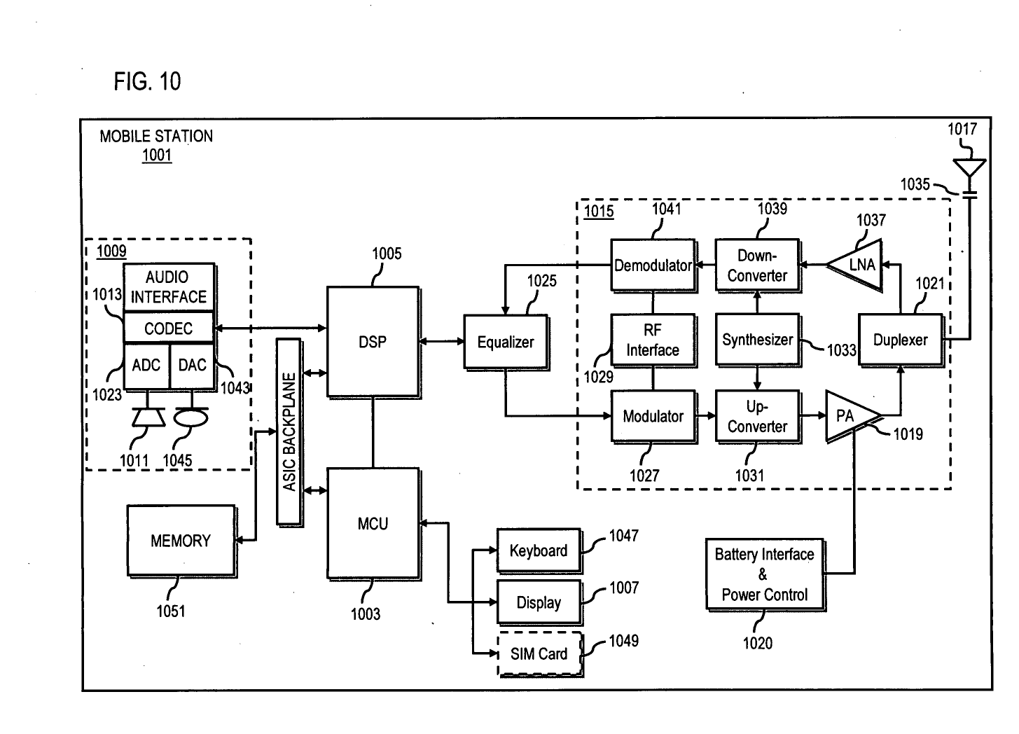

FIG. 10 is a diagram of exemplary components of a mobile station (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions that offer automatic contact matching. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile station 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile station 1001 to support geo-location search learning. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile station 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile station 1001 on a radio network. The card 1049 also contains a memory for storing a personal telephone number registry, text messages, and user specific mobile station settings.

The system 100 allows users to enter queries and to search POIs and addresses in a flexible, intelligent yet fast manner via the above-discussed splitting and sorting by relevancy scheme. As such, the user can view a recommendation list boarder than the user's contemplation and knowledge yet personally relevant.

Also, the system 100 allows users to enter queries of similarly spelled words, prompts search term suggestions, and provides geo-location recommendations, visualizes the recommended geo-locations on a map.

The system 100 uses the analytic characteristics of users groups or social groups the user belongs to sort the search results and boost relevancy of search results.

The system 100 also uses the geo-location search functionality 107 to provide offline contextual searches based on a limited data set available in the terminal device, and/or downloads new index into the device for extending the initial data set.

The system 100 improves search relevancy by analyzing popularity indicators collected to search back-end, providing context sensitivity via indicator values depend on address/landmark and time, and creates personal relevancy through like-minded users of the same social groups.

The system 100 enhances search user geo-location search experience via recommendations and collaborative filtering, suggestions of similar searches, and spelling correction.

The above capabilities advantageously permits efficient processing of searches, thereby conserving precious power, particularly in handheld mobile devices. Also, the processes yield search results quickly, and thus, reduces the need for greater processing power.

For the service providers, the system 100 generates specialized analytics geo-location search reports for planning process, so the service providers can learn what users search, detect system and data shortcomings, such as failed and bad quality searches, identify search usability issues, such as UI structure vs. actual usage, indentify regional differences and differences between client devices.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving a query specifying words;
initiating a point-of-interest search on the query, an address search on the query, and a partial search on some of the words;
combining results of the point-of-interest search, the address search, and the partial search;
determining context information for a user; and
sorting the combined results based on the context information thereby recommending the researched results to the user in a priority list as sorted.

2. A method of claim 1, wherein the context information includes past usage and behaviors of the user or past usage, and behaviors of a social group which the user belongs to.

3. A method of claim 1, wherein the point-of-interest search, the address search, and the partial search are initiated in parallel.

4. A method of claim 1, wherein the partial search comprises at least one partial address search and at least one partial landmark search.

5. A method of claim 4, wherein each of said partial address search and said one partial landmark search comprises:
splitting the query into subqueries that are groups of different numbers of words; and
conducting an address search or a landmark search for each of the subqueries to provide search results of said partial address or landmark search.

6. A method of claim 1, wherein the step of combining results comprises:
when a fully matched POI search result is located within a predetermined distance from of a current location of the user is available, adding the fully matched POI search result on the top of the priority list and skipping partial matched POI searches;
when there is no fully matched POI search result located within the predetermined distance from of a current location of the user, conducting partial near-by POI searches thereby processing the step of combining results with partially matched near-by POI search results and skipping fully matched global POI searches;
when there is no partially matched near-by POI search result available, and processing the step of combining results with fully matched global POI search results;

7. A method of claim 1, wherein the step of combining results comprises:
searching for a fully matched address search result;
determining if the fully matched address search result is a street;
when the fully matched address search result is not the street, processing the step of combining results with the fully matched address search result, and ignoring partial matched address search results; and
when the fully matched address search result is a street, processing the step of combining results with only the street, and ignoring all other matched address search results.

8. A method of claim 1, wherein the step of combining results comprises:
determining whether there are fully or partially matched POI search results;
when there is no fully or partially matched POI search result, ending the step of combining results;
when there is a fully or partially matched POI search result, adding a best fully matched address search result on the top of a final search result list;
determining whether a fully matched POI search result matches with a fully matched address search result;
where there is no fully matched POI search result matching with a fully matched address search result, ending the step of combining results; and
when there is a fully matched POI search result matching with a fully matched address search result, sorting a final search result list by distance.

9. An apparatus comprising:
at least one processor; and
at least one memory including computer program code,
wherein the at least one memory and the computer program code configured to, with the at least one processor, cause the apparatus to perform at least the following:
receiving a query specifying words;
initiating a point-of-interest search on the query, an address search on the query, and a partial search on some of the words;
combining results of the point-of-interest search, the address search, and the partial search;
determining context information for a user; and
sorting the combined results based on the context information thereby recommending the researched results to the user in a priority list as sorted.

10. An apparatus of claim 9, wherein the context information includes past usage and behaviors of the user or past usage, and behaviors of a social group which the user belongs to.

11. An apparatus of claim 9, wherein the partial search comprises at least one partial address search and at least one partial landmark search.

12. An apparatus of claim 9, wherein the apparatus is a mobile phone further comprising:
user interface circuitry and user interface software configured to facilitate user control of at least some functions of the mobile phone through use of a display and configured to respond to user input; and
a touch screen display and display circuitry configured to display at least a portion of a user interface of the mobile phone, the display and display circuitry configured to facilitate user control of at least some functions of the mobile phone and the specifying of the query.

13. An apparatus of claim 9, wherein the apparatus is further caused to: splitting the query into subqueries that are groups of different numbers of words; and
conducting an address search or a landmark search for each of the subqueries to provide search results of said partial address or landmark search.

14. An apparatus of claim 9, wherein the apparatus is further caused to:
search for a fully matched address search result;
determine if the fully matched address search result is a street;
when the fully matched address search result is not the street, process the step of combining results with the fully matched address search result, and ignore partial matched address search results; and
when the fully matched address search result is a street, process the step of combining results with only the street, and ignore all other matched address search results.

15. An apparatus of claim 9, wherein the apparatus is further caused to:
determine whether there are fully or partially matched POI search results;
when there is no fully or partially matched POI search result, end the step of combining results;
when there is a fully or partially matched POI search result, add a best fully matched address search result on the top of a final search result list;
determine whether a fully matched POI search result matches with a fully matched address search result;
where there is no fully matched POI search result matching with a fully matched address search result, end the step of combining results; and
when there is a fully matched POI search result matching with a fully matched address search result, sort a final search result list by distance.

16. A computer-readable storage medium carrying one or more sequences of one or more instructions which, when executed by one or more processors, cause an apparatus to perform at least the following:
receiving a query specifying words;
initiating a point-of-interest search on the query, an address search on the query, and a partial search on some of the words;
combining results of the point-of-interest search, the address search, and the partial search;
determining context information for a user; and
sorting the combined results based on the context information thereby recommending the researched results to the user in a priority list as sorted.

17. A computer-readable storage medium of claim 16, wherein the context information includes past usage and behaviors of the user or past usage, and behaviors of a social group which the user belongs to.

18. A computer-readable storage medium of claim 16, wherein the partial search comprises at least one partial address search and at least one partial landmark search.

19. A computer-readable storage medium of claim 18, wherein the apparatus is caused to further perform:
splitting the query into subqueries that are groups of different numbers of words; and
conducting an address search or a landmark search for each of the subqueries to provide search results of said partial address or landmark search.

20. A computer-readable storage medium of claim 16, wherein the apparatus is caused to further perform:
searching for a fully matched address search result;
determining if the fully matched address search result is a street;
when the fully matched address search result is not the street, processing the step of combining results with the fully matched address search result, and ignoring partial matched address search results; and
when the fully matched address search result is a street, processing the step of combining results with only the street, and ignoring all other matched address search results.
